(19) United States
(12) Patent Application Publication
(10) Pub. No.: US 2023/0284692 A1
(43) Pub. Date: Sep. 14, 2023

(54) Aerosol Generating Device with Lip Seal for Battery Degassing Mitigation

(71) Applicant: JT International SA, Geneva (CH)

(72) Inventor: Peter Loveday, Epsom Surrey (GB)

(73) Assignee: JT International SA, Geneva (CH)

(21) Appl. No.: 18/019,958

(22) PCT Filed: Aug. 9, 2021
(86) PCT No.: PCT/EP2021/072154

§ 371 Date: Feb. 6, 2023

(30) Foreign Application Priority Data
Aug. 10, 2020 (EP) 20190247.5

(51) Int. Cl. A24F 40/42; A24F 40/10

(52) U.S. Cl. CPC A24F 40/42; A24F 40/10

(57) ABSTRACT

An aerosol generating device includes an outside casing containing a battery and having a receiving cavity for receiving a cartomizer, and a power supply interfacing member connected to the battery and positioned inside the receiving cavity. The device further includes a sealing arrangement between the power supply interfacing member and the outside casing, wherein the sealing arrangement has a sealing lip, the sealing lip extends from the power supply interfacing member to flex against the outside casing and is orientated to extend in the direction of the battery.

### CROSS REFERENCE

Any features essential to the European patent applications titled “AEROSOL GENERATING DEVICE”, “SHOCK ABSORPTION IN A HANDHELD AEROSOL GENERATION DEVICE”, “AEROSOL GENERATING DEVICE” and “AEROSOL GENERATING DEVICE WITH A SEALED CHAMBER FOR ACCOMMODATING A BATTERY” all filed Aug. 10, 2020 having application numbers 20 190 248.3, 20 190 300.2, 20 190 249.1 and 20 190 246.7, as well as the corresponding PCT applications all filed Aug. 9, 2021, such as the claims thereof, and/or contained therein and corresponding to and/or relating to features of the present application are incorporated herein by this reference and can be combined with feature combinations disclosed herein in order to provide an improved aerosol generating device, and protection may be sought for the resulting feature combinations.

### TECHNICAL FIELD

The present invention relates to an aerosol generating device, in particular an electronic cigarette or vaporizer, with a lip seal for battery degassing mitigation.

### TECHNICAL BACKGROUND

Aerosol generating devices, such as electronic cigarettes or “e-cigarettes” as they are also known, have gained in popularity over the past ten years as an alternative to traditional smoking articles, like cigarettes, cigars, and cigarillos. Developments in the design and configuration of such aerosol generating devices or vaporizer devices are on-going to improve their performance and their reliability, as well as their ease of production and their production costs.

Conventional aerosol generating devices usually include a heater powered by an electrical power source and a liquid reservoir containing flavoured liquid that can be volatized using the heater and transferred to a user of the aerosol generating device in an airflow, which is preferably guided through a mouthpiece of the device.

Such devices are usually powered by a battery installed inside a housing. To protect the battery from external influences like dust or humidity, the battery is preferably surrounded by protection walls.

However, in some rare cases, it has happened that the battery overheats and emits high pressure gases, which can harm the user when accidently inhaled. Yet, due to the desire to maintain a product form consisting of a single piece rigid outer skin whose singular opening aperture is significantly smaller than a desired sealing perimeter, a sealing solution is required that provides a sealing that is gaseous and liquid tight whilst being compliant to the outer skin of the device and able to easily pass through the opening aperture.

### SUMMARY OF THE INVENTION

In view of the above, there is the desire to provide an aerosol generating device with a sealing arrangement that is capable of containing gaseous or liquid leakage within the device having preferably a non-uniform cross section with a limiting opening aperture, whilst maintaining ease of assembly and using food grade compliant materials.

This aim may be achieved by an aerosol generating device as defined in claim 1. Embodiments may be found in the dependent claims, the following description and the accompanying drawings.

Accordingly, a first aspect of the present invention refers to an aerosol generating device including an outside casing containing a battery and including a receiving cavity for receiving a cartomizer, a power supply interfacing member connected to the battery and positioned inside the receiving cavity, wherein the device further includes a sealing arrangement arranged between the power supply interfacing member and the outside casing, wherein the sealing arrangement comprises a sealing lip.

Hence, an aerosol generating device is provided, capable of sealing a battery accommodated inside an outside casing against external influences like dust or humidity and containing a battery degassing process within the casing whilst maintaining ease of assembly.

According to a second aspect of the present invention, the sealing lip may be arranged circumferentially about or around the power supply interfacing member.

Moreover, the sealing lip may extend from the power supply interfacing member to deform or flex against the outside casing, in particular radially outwards.

According to a third aspect of the present invention, the sealing lip may be orientated to extend in the direction of the battery, in particular towards the battery.

Furthermore, the sealing lip may be configured or formed as a continuous skirt around the power supply interfacing member.

According to a fourth aspect of the present invention, the power supply interfacing member may include a PCB (printed circuit board) to which are connected electrical connectors accessible in the receiving cavity of the outside casing to the cartomizer and a further sealing arrangement configured or formed for sealing the connectors to prevent liquid coming from the cartomizer to reach the PCB.

According to fifth aspect of the present invention, the further sealing arrangement is formed as a single element or integrally with the sealing arrangement, in particular with the sealing lip.

According to sixth aspect of the present invention, the sealing arrangement, in particular the sealing lip, and/or the further sealing arrangement may be made of silicon rubber.

Moreover, the device, in particular the outside casing, may have a non-uniform cross section, in particular along a longitudinal direction of the outside casing. In other words, along an insertion direction of components into the outside casing.

Yet, a cross-sectional area of the outside casing may increase from an opening aperture, in particular from a singular opening aperture, of the outside casing along a longitudinal direction of the outside casing, in particular towards the battery.

According to a seventh aspect of the present invention, an outer diameter or a circumference length of the sealing lip in a relaxed state, in particular in a not into the outside casing inserted state, is larger than an inner diameter or circumference length of an opening aperture of the outside casing.

Moreover, the outside casing may be formed of a rigid material, in particular a rigid thermoplastic material, glass or metal.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, in which:

FIG. 1 shows a sectional view of a conventional aerosol generating device having a housing consisting of a control body and a tank;

FIG. 2 shows a schematic sectional front view of an aerosol generating device according to an embodiment of the present invention;

FIG. 3 shows a schematic sectional front view of the sealing arrangement of the aerosol generating device of FIG. 2 in a not inserted state;

FIG. 4 illustrates the assembly of the sealing arrangement of the embodiment shown in FIG. 2 by using a jig;

FIG. 5 shows a schematic spatial view of a whole aerosol generating device according to the present invention; and

FIG. 6 shows a schematic spatial view of an embodiment of the aerosol generating device in which the sealing arrangement and the further sealing arrangement are formed integrally.

### DETAILED DESCRIPTION

Embodiments of the present disclosure will now be explained with reference to the drawings. It will be apparent to those skilled in the field of aerosol generating devices from this disclosure that the following description of the embodiments is provided for illustration only and not for the purpose of limiting the disclosure as defined by the appended claims. Features of the embodiments described below can also be used to further characterize the device defined in the claims.

Modifications of features can be combined to form further embodiments. Features described in individual embodiments can be provided in a single embodiment if they are not incompatible. Likewise, features described in a single embodiment can be provided in several embodiments individually or in any suitable sub-combination. As used in the specification and the appended claims, the singular forms “a”, “an”, “the” and the like include plural referents unless the context clearly dictates otherwise.

The same reference numerals listed in different figures refer to identical, corresponding or functionally similar elements.

As described hereinafter, example implementations of the present disclosure relate to aerosol generating devices or aerosol delivery devices. Aerosol generating devices according to the present invention use electrical energy to heat a material (preferably without combusting the material to any significant degree and/or without significant chemical alteration of the material) to form an inhalable substance or vapor; and components of such device have the form of articles that most preferably are sufficiently compact to be considered hand-held devices. That is, use of components of preferred aerosol generating devices does not result in the production of smoke in the sense that aerosol results principally from by-products of combustion or pyrolysis of tobacco, but rather, use of those devices preferably results in the production of vapors resulting from volatilization or vaporization of certain components incorporated therein.

In some example implementations, components of aerosol generating devices may be characterized as electronic cigarettes, and those electronic cigarettes preferably incorporate aerosolisable liquid (e.g. propylene glycol, polyhydric alcohol), tobacco and/or tobacco materials derived at least partially from tobacco, and hence deliver tobacco derived components in aerosol or vapor form to a user. In more detail, aerosol generating devices within the meaning of the present invention may transport the volatilized particles in an airflow through the aerosol generating device to a user of the device, the user of the device being able to activate or deactivate the generation of aerosol and to control the duration, velocity and volume of the airflow by means of puffing or inhaling action.

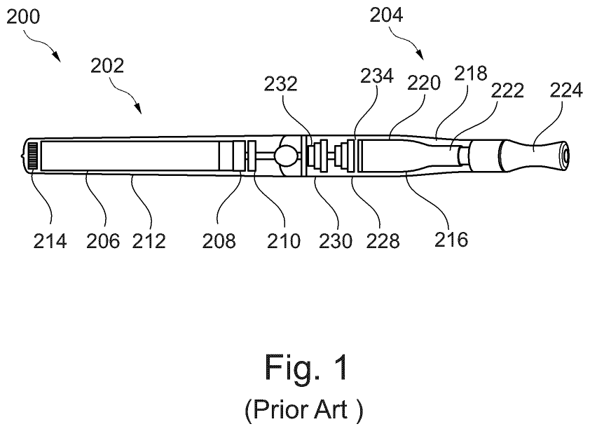

FIG. 1 illustrates a known aerosol generating or delivery device 200 including a control body 202 and a tank 204. As shown in FIG. 1, the control body 202 can be formed of a control body shell 206 that can include a control component 208 (e.g., a printed circuit board (PCB), an integrated circuit, a memory component, a microprocessor, individually or as part of a micro-controller, and the like), a flow sensor 210, a battery 212, and one or more light-emitting diodes (LEDs) 214, and such components can be variably aligned. Moreover, the tank 204 can be formed of a tank shell 216 enclosing a reservoir 218 that is in fluid communication with a liquid transport element 220 adapted to wick or otherwise transport an aerosol precursor composition stored in the reservoir housing to a heater 222 (sometimes referred to as a heating element). A valve may be positioned between the reservoir and heater and configured to control an amount of aerosol precursor composition passed or delivered from the reservoir to the heater. The known device is provided with a mouthpiece 224 having an opening defined therein and which may be coupled to the tank shell 216 to allow for egress of formed aerosol from the tank 204. The shown device 200, in particular the control body 202 and the tank 204, include a coupler 230 having a cavity 232 therein.

A base 228 of the tank is adapted to engage the coupler and includes a projection 234 to fit within the cavity.

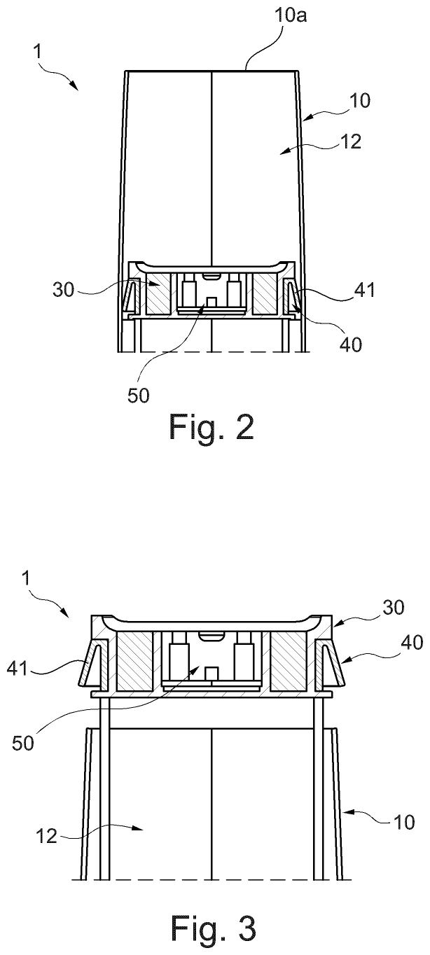

FIG. 2 shows a schematic sectional front view of an aerosol generating device 1 according to an embodiment of the present invention. As shown in FIG. 2, the aerosol generating device comprises an outer casing 10 for accommodating a battery 11 (not shown) and having a cavity 12 for receiving a cartomizer 20 (visible in FIG. 5). The shown aerosol generating device 1 further comprises a power supply interfacing member 30 which is also located within the outside casing 10, in particular within the cavity 12.

Aerosol generating devices of the present invention generally include a number of components provided within an outer body or shell, which may be referred to as an outside casing or housing. The overall design of the outside casing can vary, and the format or configuration of the outside casing that can define the overall size and shape of the aerosol generating device can vary. For some aerosol generating devices, an elongated body resembling the shape of a cigarette or cigar can be formed from a single, unitary housing, or the elongated housing can be formed of two or more separable bodies. For example, an aerosol generating device can include an elongated shell or body (outside casing) that can be substantially tubular in shape and, as such, resemble the shape of conventional cigarettes or cigars. In one implementation, all of the components of the aerosol generating device are contained within a single housing. Alternatively, an aerosol delivery device can comprise two or more housings that are joined and are separable.

Aerosol generating devices of the present invention can be formed of an outside casing or shell that is not substantially tubular in shape but may be formed to substantially greater transversal dimensions. The outside casing or shell can be configured to include a mouthpiece and/or may be configured to receive a separate shell (e.g. a cartridge, a tank) that can include consumable elements, such as a liquid aerosol former, and can include a vaporizer.

As can be taken from FIG. 2, the shown aerosol generating device 1 further includes a sealing arrangement, which is arranged between the power supply interfacing member 30 and the outside casing 10. The shown sealing arrangement 40 includes a sealing lip 41, which is arranged circumferentially around the power supply interfacing member 30. Thereby, the sealing lip 41 closes a gap between an inner surface of the outer casing 10 and an outer circumference of the power supply interfacing member 30.

The outside casing 10 includes an opening aperture 10a, in particular a singular opening aperture, for inserting at least parts of the components of the aerosol generating device 1 into the outside casing 10. As shown in FIG. 2, the outside casing 10 has a non-uniform cross section along a longitudinal direction of the outside casing 10. In more detail, a cross-sectional area of the outside casing 10 increases from the opening aperture 10a of the outside casing 10 along the longitudinal direction of the outside casing, particular towards the battery 11. In other words, an inner diameter or circumference length of the outside casing 10 (diameter or circumference length of the cavity 12) increases from the opening aperture 10a towards the battery 11 (inserting position of the battery 11 into the outside casing 10).

The sealing arrangement 40, in particular the sealing lip 41, is inserted into a groove provided in an outer circumferential surface of the power supply interfacing member 30. As shown in FIG. 2, the sealing lip 41 extends from the power supply interfacing member towards the outside casing 10, in particular an inner surface of the outside casing 10, to deform or flex against the outside casing 10.

FIG. 2 shows also that the sealing lip 41 is orientated to extend in the direction of the battery 11, in particular towards the battery 11. In other words, the sealing lip 41 extends in a direction in which at least some of the components of the aerosol generating device are inserted into the outside casing 10.

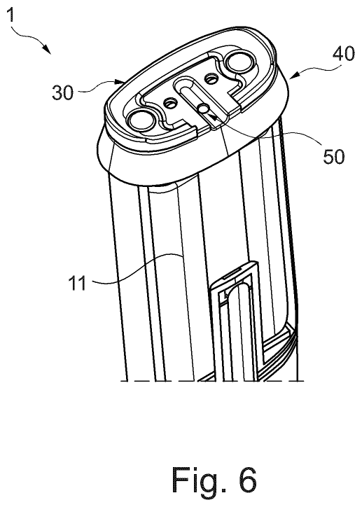

FIG. 3 shows a schematic sectional front view of the sealing arrangement 40 of the aerosol generating device 1 of FIG. 2 in a not inserted state. FIG. 3 illustrates that an outer circumference length of the sealing lip 41 in a relaxed state, namely in a state in which the sealing lip 41 is not inserted into the outside casing 10. As the sealing lip 41 as shown in FIGS. 5 and 6 is formed as a continuous skirt which runs around the power supply interfacing member 30 having a close to oval form, the size of the cross-sectional area is expressed by the outer circumference length.

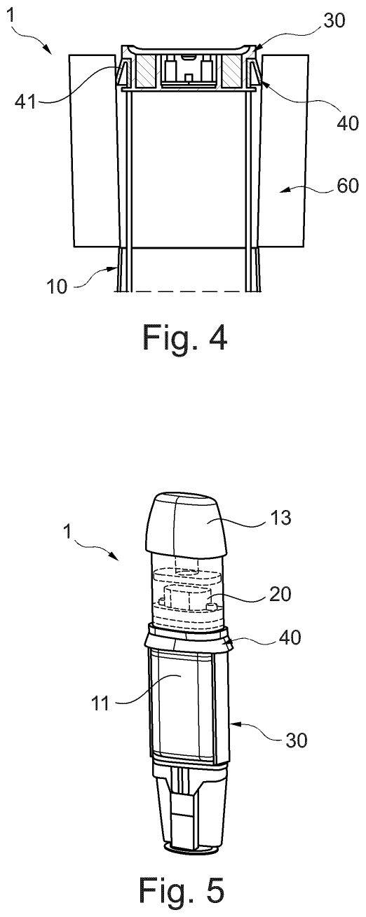

As also shown in FIG. 3, the illustrated aerosol generating device 1 has a further sealing arrangement 50, which is arranged or formed for sealing electrical connectors such as “pogo pins” (visible in FIG. 6) of a PCB (printed circuit board) (visible in FIG. 4). The electrical connectors are accessible in the receiving cavity 12 for supplying a heater for example with electric power from the battery 11. The sealing arrangement 50 is formed for sealing the electrical connectors in such a way that liquid coming from the cartomizer 20 is prevented from reaching the PCB.

FIG. 4 illustrates the assembly of the sealing arrangement of the embodiment shown in FIG. 2 by using a jig 60. As explained above, the outer diameter or outer circumference length of the sealing lip 41 in the relaxed state is greater than the inner diameter or circumference length of the opening aperture 10a of the outside casing 10. Hence, a direct assembly or insertion of the sealing arrangement 40 into the outside casing 10 is difficult or even not possible, at least without risking damaging the sealing lip 41.

Hence, when inserting the power supply interfacing member 30 provided with the sealing arrangement 40 into the outside casing 10, a jig (installation jig) 60 is used which has a tapered form, at least in the inside. Thereby, when inserting the sealing arrangement 40 with the power supply interface member 30 into the outside casing 10, the sealing lip 41 is gradually compressed by the tapered inner surface of the jig 60. The gradual taper of the jig prevents reversion of the sealing lip 41 which would result in either binding of the insertion procedure or damaging the seal 40, in particular the sealing lip 41. By compressing the sealing lip 41, the sealing lip 41 is slowly moved towards the power supply interface member 30, thereby increasing a restoring force urging the sealing lip 41 towards the inner surface of the outside casing 10. By arranging the sealing lip 41 within the outside casing 10 in a reverse mounting position as usually, the sealing lip 41 is able to deflect and conform to an internal profile of the outside casing 10 whilst allowing easy installation of the outer skin over the inner frame of the device by using the tapered installation jig.

With the reversed seal arrangement an increase of internal pressure, for example caused by battery degassing, forces the seal to create a stronger seal as the internal pressure forces the seal into the surrounding skin (outside casing 10) providing safer operation.

FIG. 5 shows a schematic spatial view of a whole aerosol generating device 1 according to the present invention. As shown in FIG. 5, the illustrated aerosol generating device includes the outside casing 10, which is for illustrating purposes not shown, a mouthpiece 13 for guiding the generated vapor to a user, the sealing arrangement 40 including the sealing lip 41 and the power supply interface member 30 accommodating the battery 11. The mouthpiece 13 may be a part of the outside casing 10 or might be attachable to the outside casing.

Moreover, FIG. 6 shows a schematic spatial view of an embodiment of the aerosol generating device 1 in which the sealing arrangement 40 with the sealing lip 41 and the further sealing arrangement 50 are formed integrally. In more detail, the further sealing arrangement 50 is integrated into the power supply interface member 30, thereby making it possible that electrical connectors coming from the battery 11 and leading to for example a heater arranged in the receiving cavity 12, can be sealed against liquid leaking from the cartomizer 20. As illustrated in FIG. 6, the sealing arrangement 40 formed as a continuous skirt around the power supply interfacing member is formed integrally with the further sealing arrangement 50.

### REFERENCE LIST

1 Aerosol generating device
10 Outside casing
11 Battery
12 Receiving cavity
13 Mouthpiece
20 Cartomizer
30 Power supply interfacing member
40 Sealing arrangement
41 Sealing lip
50 further Sealing arrangement
60 Jig

1. An aerosol generating device comprising:
an outside casing containing a battery and comprising a receiving cavity for receiving a cartomizer, and
a power supply interfacing member connected to the battery and positioned inside the receiving cavity,
wherein the device further comprises a first sealing arrangement between the power supply interfacing member and the outside casing, and
wherein the first sealing arrangement comprises a sealing lip, the sealing lip extends from the power supply interfacing member to flex against the outside casing and is orientated to extend in the direction of the battery.

2. The aerosol generating device according to claim 1, wherein the sealing lip is arranged circumferentially about the power supply interfacing member.

3. The aerosol generating device according to claim 1, wherein the sealing lip is orientated to extend towards the battery.

4. Aerosol generating device according to claim 1, wherein the sealing lip is configured as a continuous skirt around the power supply interfacing member.

5. The aerosol generating device according to claim 1, wherein the power supply interfacing member comprises a printed circuit board (PCB) to which are connected electrical connectors accessible in the receiving cavity to the cartomizer, and a second sealing arrangement configured for sealing the connectors to prevent liquid coming from the cartomizer to reach the PCB.

6. The aerosol generating device according to claim 5, wherein the second sealing arrangement is formed as a single element or integrally with the sealing lip.

7. The aerosol generating device according to claim 5, wherein the first sealing arrangement and/or the second sealing arrangement is made of silicone rubber.

8. The aerosol generating device according to claim 1, wherein the outside casing, has a non-uniform cross section along a longitudinal direction of the outside casing.

9. The aerosol generating device according to claim 1, wherein a cross-sectional area of the outside casing increases from an opening aperture of the outside casing along a longitudinal direction of the outside casing towards the battery.

10. The aerosol generating device according to claim 1, wherein an outer diameter or a circumference length of the sealing lip in a relaxed state, is larger than an inner diameter or circumference length of an opening aperture of the outside casing.

11. The aerosol generating device according to claim 1, wherein the outside casing is formed of a rigid material.

12. The aerosol generating device according to claim 11, wherein the outside casing is formed of a rigid thermoplastic material, glass or metal.

13. The aerosol generating device according to claim 2, wherein the sealing lip is orientated to extend towards the battery.
